(19) United States
(12) Patent Application Publication
(10) Pub. No.: US 2022/0014076 A1
(43) Pub. Date: Jan. 13, 2022

(54) MOTOR UNIT, MOTOR OPERATION DISPLAY SYSTEM, AND MOTOR OPERATION DISPLAY DEVICE

(71) Applicant: Nidec Corporation, Kyoto (JP)

(72) Inventor: Tetsuzo NAGAHISA, Kyoto (JP)

(21) Appl. No.: 17/293,633

(22) PCT Filed: Nov. 27, 2019
(86) PCT No.: PCT/JP2019/046323

§ 371 Date: May 13, 2021

(30) Foreign Application Priority Data
Nov. 29, 2018 (JP) 2018-223378

(51) Int. Cl. H02K 11/21; H02K 11/26; H02K 11/27; G08B 21/18; G08B 1/08

(52) U.S. Cl. CPC H02K 11/21; H02K 11/26; G08B 1/08; G08B 21/185; H02K 11/27

(57) ABSTRACT

A motor assembly includes a motor and a microcomputer attached to the motor. The microcomputer includes a storage to store motor operation data from a time of starting the motor, and a communicator to, upon receiving a request for the motor operation data, read the requested motor operation data from the storage and transmit the requested motor operation data.

### CROSS REFERENCE TO RELATED APPLICATIONS

This is a U.S. national stage of PCT Application No. PCT/JP2019/046323, filed on Nov. 27, 2019, with priority under 35 U.S.C. § 119(a) and 35 U.S.C. § 365(b) being claimed from Japanese Application No. 2018-223378, filed Nov. 29, 2018, the entire disclosures of which are hereby incorporated herein by reference.

### 1. FIELD OF THE INVENTION

The present disclosure relates to a motor assembly, a motor operation display system, and a motor operation display device.

### 2. BACKGROUND

A display device that display an operating state of a motor is known. Such a display device is disclosed in, for example, Japanese Patent Application No. 2015-19466.

Japanese Patent Application No. 2015-19466 discloses a motor operating state display device that displays the operating state of a motor arranged in a game machine or the like as a non-schematic image. The display device for displays the operating state of a motor in Japanese Patent Application No. 2015-19466 creates a diagram for displaying the operating state of the motor on coordinate space using coordinate space data and motor operation data, and displays graphics on a display screen.

In the motor operating state display device of Japanese Patent Application No. 2015-19466, when coordinate space data and motor operation data occurs, at least part of the content to be displayed cannot be displayed.

### SUMMARY

Example embodiments of the present disclosure provide motor assemblies, motor operation display systems, and motor operation display devices that each reduce the influence of data loss.

A motor assembly of a first example embodiment of the present disclosure includes a motor and a microcomputer attached to the motor. The microcomputer includes a storage to store motor operation data, which is operation data at the time of starting the motor, and a communicator to, upon receiving a request for the motor operation data, read the requested motor operation data from the storage and transmit the requested motor operation data.

A motor operation display system of a second example embodiment of the present disclosure includes a requestor to request the motor operation data of the storage, and a display controller to cause a display to display motor operation information based on the motor operation data requested by the requestor.

A motor operation display device of a third example embodiment of the present disclosure includes a motor operation display system and a display to display motor operation information.

According to an example embodiment of the present disclosure, it is possible to provide motor assemblies, motor operation display systems, and motor operation display to reduce the influence of data loss.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic diagram of a motor operation display device according to an example embodiment of the present disclosure.

FIG. 2 is a cross-sectional view of a motor assembly according to an example embodiment of the present disclosure.

FIG. 3 is a functional block diagram of a motor operation display system according to an example embodiment of the present disclosure.

FIG. 4 is a diagram showing motor operation data stored in a storage according to an example embodiment of the present disclosure.

FIG. 5 is a schematic diagram showing a state in which noise is generated in a motor operation display system of an example embodiment of the present disclosure.

FIG. 6 is a schematic diagram showing a state in which noise is generated in a motor operation display system of an example embodiment of the present disclosure.

FIG. 7 is a flowchart showing a motor operation display method according to an example embodiment of the present disclosure.

### DETAILED DESCRIPTION

Hereinafter, example embodiments of the present disclosure will be described with reference to the drawings. Note that, the same reference numeral is attached to the same or corresponding parts in diagrams below, and description of the parts will not be repeated.

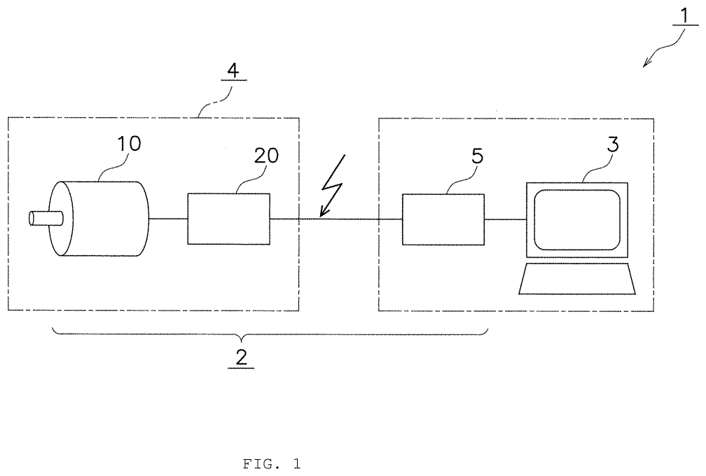

A motor assembly, a motor operation display system, and a motor operation display device according to an example embodiment of the present disclosure will be described with reference to FIGS. 1 to 6.

As shown in FIG. 1, a motor operation display device 1 includes a motor operation display system 2 and a display device 3. The display device 3 displays operation information of a motor based on operation data of the motor acquired by the motor operation display system 2. The display device 3 is, for example, a display of a personal computer (PC). A control unit of the motor operation display device 1 is realized by, for example, an arithmetic processing unit such as a central processing unit (CPU).

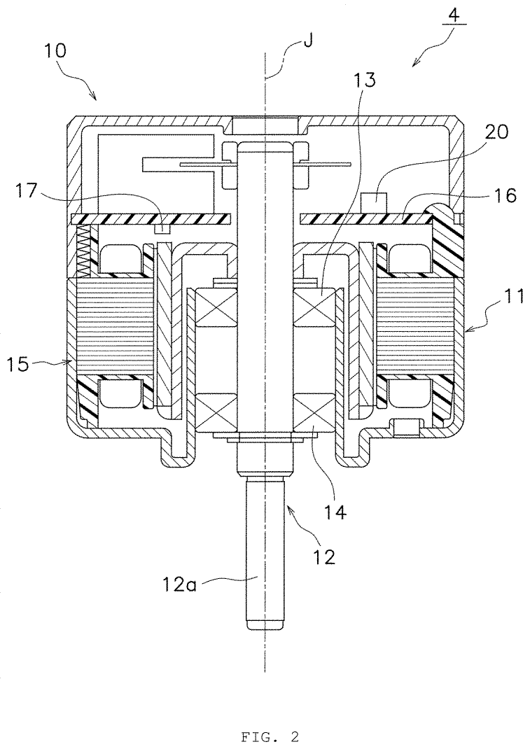

The motor operation display system 2 includes a motor assembly 4 shown in FIG. 2 and an information acquisition unit 5. The information acquisition unit 5 acquires operation data of a motor from the motor assembly 4.

The motor assembly 4 and the information acquisition unit 5 are connected by radio or by wire. In the latter case, the motor operation display system 2 further includes a communication line connecting the motor assembly 4 and the information acquisition unit 5.

The information acquisition unit 5 causes the display device 3 to display operation information of a motor. The display device 3 and the information acquisition unit 5 may be integrated or separate.

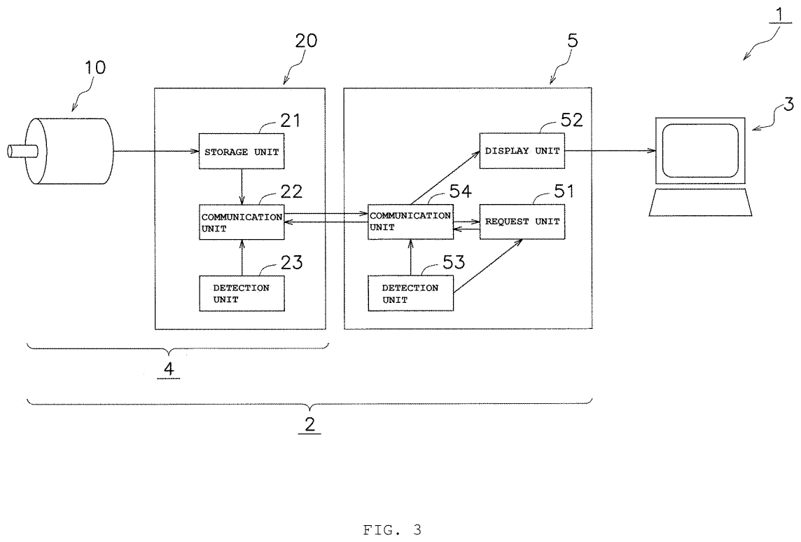

As shown in FIG. 3, the information acquisition unit 5 of the motor operation display system 2 includes a requestor 51, a display assembly 52, a second detector 53, and a second communicator 54. Description of each configuration of the information acquisition unit 5 will be described later.

As shown in FIGS. 1 to 3, the motor assembly 4 includes a motor 10 and a microcomputer 20 (hereinafter, also referred to as “microcomputer 20”). The microcomputer 20 is attached to the motor 10. The microcomputer 20 may be directly attached to a member constituting the motor 10, or may be attached with another member interposed between them.

### <Motor>

As shown in FIG. 2, the motor 10 includes a housing 11, a rotor 12, bearings 13 and 14, a stator 15, a substrate 16, and an electronic component 17. The housing 11 is housed inside the rotor 12 and the stator 15.

The rotor 12 has a shaft 12a. The shaft 12a extends in an axial direction along a central axis J. The shaft 12a is supported by a pair of the bearings 13 and 14, and rotates about the central axis J. The stator 15 encloses the outer side in the radial direction of the rotor 12.

The substrate 16 is disposed on the upper side in the axial direction of the stator 15. The electronic component 17 such as a magnetic sensor is mounted on the substrate 16.

### <Microcomputer>

The microcomputer 20 is mounted on the substrate 16. Since this microcomputer 20 controls the motor 10, circuit design in which noise is unlikely to enter is sufficiently made for a communication path for a control signal to the motor 10 and a sensing information signal from the motor 10. As shown in FIG. 3, the microcomputer 20 includes a storage 21, a first communicator 22, and a first detector 23.

The storage 21 stores motor operation data, which is operation data when the motor 10 is started. The storage 21 is realized by, for example, a RAM or the like. The motor operation data means data indicating an operating state of at least part of motors from the start of rotation of the rotor 12 to the steady operation. Specifically, the motor operation data may be all pieces of data at the time of starting, or may be part of data at the time of starting.

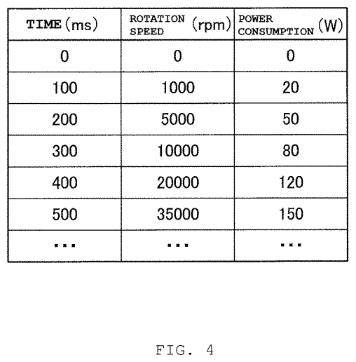

The motor operation data is, for example, power consumption, rotation speed, temperature, and the like for a predetermined time from the start of rotation. As shown in FIG. 4, the storage 21 of the present example embodiment stores the rotation speed and the power consumption every 100 ms, with the rotation start at 0 ms.

The storage 21 averages a plurality of pieces of data acquired while storing each piece of motor operation data, and stores the averaged data. In the example shown in FIG. 4, for example, data of rotation speed and power consumption is acquired at 1-ms intervals, and when the time reaches 100 ms, the average of 100 pieces of data is calculated and stored in the storage 21 as rotation speed and power consumption at 100 ms. In this manner, the storage 21 can store the motor operation data with reduced temporal variation. For this reason, an operating state at the time of starting of the motor 10 can be accurately grasped.

The motor operation data stored in the storage 21 is deleted when the motor is newly started. That is, the motor operation data stored in the storage 21 is temporarily stored data and is overwritten when the motor is newly started.

When receiving a request for the motor operation data, the first communicator 22 reads the requested motor operation data from the storage 21 and transmits the requested motor operation data. That is, the first communicator 22 selects the motor operation data corresponding to the request from the requestor 51 from the storage 21, and transmits the selected motor operation data to the display assembly 52.

The time interval at which the first communicator 22 receives the request for the motor operation data is shorter than the time interval in which the storage 21 stores each piece of the motor operation data. That is, the motor operation data is requested by the first communicator 22 at the interval shorter than the time interval in which the storage 21 stores each piece of the motor operation data. For this reason, the information acquisition unit 5 on the requesting side can shorten a time lag for acquiring the motor operation data. For example, the time interval in which the storage 21 stores each piece of the motor operation data is controlled to be twice or more the time interval in which the first communicator 22 receives the request.

Specifically, the time interval in which the storage 21 stores each piece of the motor operation data is larger than {(a communication information amount when the motor operation data is requested to the microcomputer 20)+(a communication information amount when the motor operation data is transmitted from the microcomputer 20)}×(the number of times of communication to acquire the motor operation data at each requested time)/(the communication speed). Here, an example of the time interval in which the storage 21 stores each piece of the motor operation data is given. In the present example embodiment, the communication speed between the microcomputer 20 and the information acquisition unit 5 is 9600 bps. In the present example embodiment, both the communication information amount when 20 pieces of the motor operation data of 20 is requested to the microcomputer and the communication information amount when the motor operation data is transmitted from the microcomputer 20 are 7 bytes. Here, 1 byte is 8 bits. The breakdown when the motor operation data is requested includes 1 byte as information indicating an item (rotation speed, power consumption, and the like) of the requested motor operation data, 1 byte as information of the time after starting (100 ms, 200 ms, and the like), 4 bytes for reserved (filled with zeros in relation to other communication specifications), and 1 byte for communication error detection. The breakdown at the time of data transmission includes 1 byte as information indicating items (rotation speed, power consumption, and the like) of the motor operation data to be transmitted, 1 byte as information of the time after starting (100 ms, 200 ms, and the like), 4 bytes for the motor operation data, and 1 byte for communication error detection. The number of times of communication for acquiring the motor operation data at each requested time is the number of times of communication required for acquiring and displaying the motor operation data for certain time after starting of a motor stored in the storage 21. For example, in a case where data of one item is acquired for each time of communication, the number of times of communication in the present example embodiment is two, since data of two items, rotation speed and power consumption, in FIG. 4 are acquired in two times of communication. Further, in another example, the number of times of communication may be one by compressing a plurality of pieces of information and acquiring data of two items in one time of communication. Here, compression is performed by a method of, for example, reducing the resolution of data of 4 bytes to make data of one item into 2 bytes and putting the data of 2 bytes for two items into 4 bytes of the motor operation data. For this reason, the time interval in which the storage 21 stores each piece of the motor operation data is larger than {7 (bytes)+7 (bytes)}×8 (bits/byte)×2/9600 (bps)=23.3 ms. Since the inquiry from the requestor 51 is faster than 23.3 ms, even if a communication error is detected by the first detector 23 and the request is made again, the data acquisition by the information acquisition unit 5 catches up with the data stored in the storage 21. For this reason, the motor operating state can be displayed on the display device 3 in almost real time, that is, only with the communication time and a time lag of the display processing.

Note that the storage 21 may further store operation data at the time of steady operation, stoppage, and the like. In this case, the first communicator 22 can read the motor operation data from the storage 21 and transmit the data during steady operation of the motor 10, when the motor 10 is stopped, after the motor 10 is stopped, and the like.

The first detector 23 detects a communication error when receiving a request for the motor operation data. When detecting a communication error, the first detector 23 notifies the information acquisition unit 5 that the communication error is detected. That is, the first detector 23 returns information including the fact that a communication error is detected to the information acquisition unit 5. When detecting a communication error, the first detector 23 may notify the information acquisition unit 5 of only that the communication error is detected, and may instruct the information acquisition unit 5 so that the first communicator 22 receives the same request.

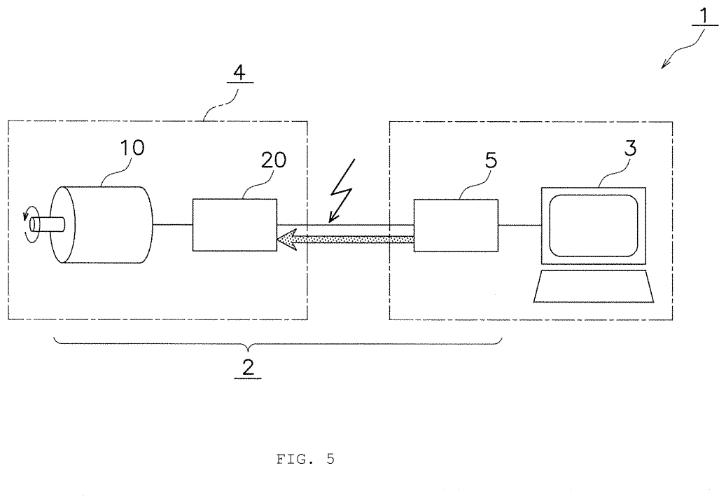

Specifically, when the first communicator 22 receives a request from the requestor 51 via the second communicator 54, and noise enters between the motor assembly 4 and the information acquisition unit 5 as shown in FIG. 5, the first detector 23 detects a communication error. Then, the first detector 23 notifies the requestor 51 via the first communicator 22 and the second communicator 54 that the communication error is detected. Upon receiving the notification, the requestor 51 re-requests the same motor operation data from the first communicator 22 via the second communicator 54. Note that the first detector 23 may instruct the first communicator 22 to send the same motor operation data to the display assembly 52.

If the communication error can be detected by the first detector 23 in this way, the same data can be re-requested from the information acquisition unit 5 even if a communication error occurs. Since the motor operation data is stored in the storage 21, the motor operation data can be read out and transmitted to the display assembly 52 in response to a re-request. For this reason, the information acquisition unit 5, which is the side that requests the motor operation data, is less affected by data loss. Therefore, it is possible to accurately grasp the operating state at the time of starting the motor 10. Furthermore, in a case where the information acquisition unit 5 includes the second detector 53 that detects a communication error, the information acquisition unit 5 side and the microcomputer 20 side can mutually check a communication error, so that the accuracy can be further improved.

The first detector 23 detects a communication error by, for example, a checksum or a parity check. The first detector 23 of the present example embodiment uses a checksum. In the present example embodiment, 1 byte for communication error detection is used as a checksum in the communication breakdown at the time of data request. The requestor 51 takes a total of 6 bytes other than the checksum, calculates a value of the lower 1 byte, and uses the value as the checksum value. On the other hand, the first detector 23 takes a total of 6 bytes other than the checksum out of the received 7 bytes, calculates a value of the lower 1 byte, collates the value with the received checksum value, and detects a communication error by determining normal if the values are the same and that there is a communication error if the values are different.

In this way, the microcomputer 20 has a function of storing the motor operation data and transmitting the data to the outside when requested. In addition to the function of transmitting the motor operation data, the microcomputer 20 may further include a function of instructing the motor 10.

Specifically, the microcomputer 20 instructs the motor 10 to operate according to a parameter input by the user. The parameter to be input is, for example, the rise time, the target power, or the like. The parameter is input by an input device of a PC, such as a keyboard and a mouse. The parameter can be set optionally. Further, the parameter can be overwritten by the user's operation.

(the information acquisition unit of the motor operation display system) As shown in FIG. 3, the information acquisition unit 5 of the motor operation display system 2 includes a requestor 51, a display assembly 52, a second detector 53, and a second communicator 54.

The requestor 51 requests the motor operation data of the storage 21. The requestor 51 requests the motor operation data from the first communicator 22 at a timing earlier than a timing at which the storage 21 stores each piece of the motor operation data. Note that this timing is determined in consideration of a communication information amount when data is requested to the microcomputer 20, a communication information amount when data is transmitted from the microcomputer 20, the number of times of communication for acquiring the motor operation data at each requested time, the communication speed, and the like.

The display assembly 52 causes the display device 3 to display the motor operation information based on the motor operation data requested by the requestor 51. Specifically, the display assembly 52 receives the motor operation data from the first communicator 22. Based on the received motor operation data, the display device 3 is instructed to display the motor operation information. The motor operation information is, for example, a graph showing a change over time in motor power consumption, where the horizontal axis is time and the vertical axis is motor power consumption.

The second detector 53 detects a communication error when receiving the motor operation data from the first communicator 22. When detecting a communication error, the second detector 53 re-requests the same motor operation data from the first communicator 22.

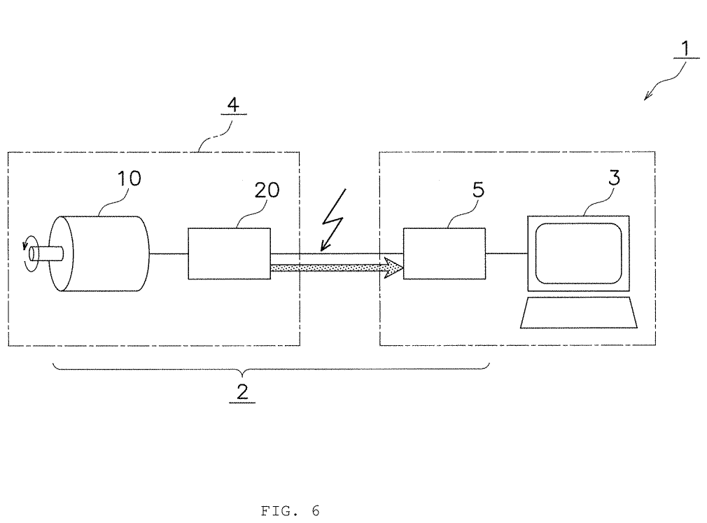

Specifically, when the second communicator 54 receives the motor operation data from the first communicator 22, and noise enters between the motor assembly 4 and the information acquisition unit 5 as shown in FIG. 6, the second detector 53 detects a communication error. Then, the second detector 53 instructs the second communicator 54 not to transmit the motor operation information to the display assembly 52. Further, the second detector 53 instructs the requestor 51 to re-request the same motor operation data. Note that the second detector 53 may request the same motor operation data from the first communicator 22 via the second communicator 54. For this reason, even if a communication error occurs, the second detector 53 can re-request the motor operation data from the first communicator 22. For this reason, since the influence of data loss is small, it is possible to accurately grasp the operating state at the time of starting the motor.

Note that the second detector 53 may detect that the motor operation data requested by the requestor 51 and the motor operation data received by the second communicator 54 are different from each other. Specifically, in the present example embodiment, pieces of information indicating the motor operation data items at the time of data request and at the time of data transmission are collated with each other, and pieces of information at the time of data request and time after starting at the time of data transmission are collated with each other. It is determined to be normal if the pieces of information indicate the same contents, and is determined to be a communication error if at least one of the pieces of information has different content. In this case, even if the first detector 23 is omitted, the communication error can be detected by the second detector 53. For this reason, the information acquisition unit 5 can re-request the motor operation data, so that the influence of data loss is small.

The second detector 53 detects a communication error by, for example, a checksum or a parity check. The second detector 53 of the present example embodiment uses a checksum. In the present example embodiment, 1 byte for communication error detection is used as a checksum in the communication breakdown at the time of data request. The first communicator 22 takes a total of 6 bytes other than the checksum, calculates a value of the lower 1 byte, and uses the value as the checksum value. On the other hand, the second detector 53 takes a total of 6 bytes other than the checksum out of the received 7 bytes, calculates a value of the lower 1 byte, collates the value with the received checksum value, and detects a communication error by determining normal if the values are the same and that there is a communication error if the values are different.

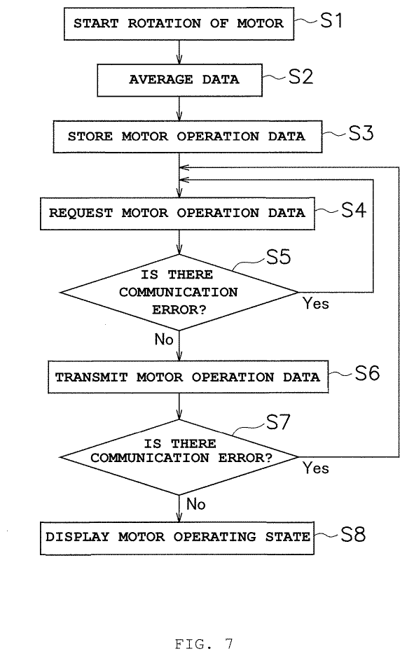

A motor operation display method in the present example embodiment will be described with reference to FIGS. 1 to 7. For subsequent operation, it is assumed that the power of the motor 10 has already been turned on. Further, starting means the start of rotation of the motor 10.

First, the motor 10 of the motor assembly 4 is started (Step S1). A plurality of pieces of data acquired while each piece of the motor operation data is stored are averaged (Step S2). Next, the averaged data is stored in the storage 21 as the motor operation data (Step S3).

The requestor 51 of the information acquisition unit 5 requests the motor operation data stored in the storage 21 (Step S4).

When the first communicator 22 receives the request from the requestor 51, the first detector 23 detects whether or not there is a communication error (Step S5). In a case where the first detector 23 detects that there is a communication error in Step S5, the requestor 51 is notified that the communication error is detected. Upon receiving this notification, the requestor 51 makes the same request to the first communicator 22 (Step S4). In contrast, if the first detector 23 determines in Step S5 that there is no communication error, the motor operation data is transmitted to the display assembly 52 (Step S6).

When the display assembly 52 receives the motor operation data from the first communicator 22, the second detector 53 detects whether or not there is a communication error (Step S7). In a case where the second detector 53 detects that there is a communication error in Step S7, the requestor 51 is notified that the communication error is detected. Upon receiving this notification, the requestor 51 makes the same request to the first communicator 22 (Step S4). In contrast, if the second detector 53 determines in Step S7 that there is no communication error, the display assembly 52 causes the display device 3 to display the motor operation information based on the motor operation data (Step S8).

Note that the control in the information acquisition unit 5 of the motor operation display system 2 may be performed by software or by using a hardware circuit. Further, a program for executing the processing of the motor operation display method may be provided, the program may be recorded on a recording medium and provided to the user, or the program may be downloaded to the display device 3 via a communication line.

As described above, in the motor assembly 4, the motor operation display system 2, and the motor operation display device 1 of the present example embodiment, the microcomputer 20 includes the storage 21 that stores the motor operation data which is the operation data when the motor 10 is started. For the communication path between the microcomputer 20, the substrate 16, and the motor 10, a circuit design in which noise is unlikely to enter is sufficiently made. For this reason, the storage 21 can store the motor operation data that is less affected by data loss. When the motor operation data is requested from the information acquisition unit 5, the first communicator 22 can send the motor operation data that is less affected by loss. Therefore, it is possible to reduce the data loss and display the operation information at the time of starting the motor 10 on the display device 3.

The motor assembly 4 of the present example embodiment includes the first detector 23. The motor operation display system 2 and the motor operation display device 1 of the present example embodiment include the second detector 53. The present inventor has found a novel problem that data loss occurs due to the generation of electromagnetic noise in a case where the rotation speed of the motor 10 is high. Furthermore, the present inventor has found that data loss is likely to occur when the motor 10 is started. When a communication error is detected by at least one of the first detector 23 and the second detector 53, the information acquisition unit 5 can re-request data from the first communicator 22. Since the motor operation data is stored in the storage 21, the motor operation data can be transmitted in response to the re-request. For this reason, the information acquisition unit 5 side that requests the motor operation data is less affected by data loss. Therefore, it is possible to accurately grasp the operating state at the time of starting the motor 10.

As described above, since the influence of data loss is small when the motor 10 is started, the operation information of the motor 10 at the time of starting can be displayed with high accuracy. For this reason, the present example embodiment is preferably used for a motor assembly including a motor that employs sensorless control, a motor operation display system, and a motor operation display device.

The example embodiments disclosed this time should be considered to be exemplary in all respects and not restrictive. Specifically, the numerical values described for the buffer time interval, the data acquisition item, the communication information amount at the time of data request to the microcomputer, the communication breakdown at the time of data request to the microcomputer, the communication information amount at the time of data transmission from the microcomputer, the communication breakdown of the communication information amount at the time of data transmission from the microcomputer, the number of times of communication for acquiring the motor operation data at each requested time, the communication speed, and the like described in the present example embodiment are examples. Further, the communication information amount at the time of data request to the microcomputer and the communication information amount at the time of data transmission from the microcomputer do not need to be the same. The scope of the present disclosure is indicated by the scope of claims, not the example embodiment described above, and is intended to include all modifications within the meaning and scope equivalent to the scope of claims.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-8. (canceled)

9. A motor assembly, comprising:
a motor; and
a microcomputer attached to the motor; wherein
the microcomputer includes a storage to store motor operation data from a time of starting the motor; and
a communicator to, upon receiving a request for the motor operation data, read the requested motor operation data from the storage and transmit the requested motor operation data.

10. The motor assembly according to claim 9, wherein the microcomputer further includes a detector to detect a communication error when receiving a request for the motor operation data, and to notify, upon detecting a communication error, that a communication error is detected.

11. The motor assembly according to claim 9, wherein a time interval in which the communicator receives a request for the motor operation data is shorter than a time interval in which the storage stores each piece of the motor operation data.

12. The motor assembly according to claim 11, wherein a time interval in which the storage stores each piece of the motor operation data is larger than {(a communication information amount when the motor operation data is requested to the microcomputer)+(a communication information amount when the motor operation data is transmitted from the microcomputer)}×(a number of times of communication for acquiring the motor operation data at each requested time)/(communication speed).

13. The motor assembly according to claim 9, wherein the storage is configured or programmed to average a plurality of pieces data acquired while storing each piece of the motor operation data, and store averaged data.

14. A motor operation display system, comprising:
the motor assembly according to claim 9;
a requestor to request the motor operation data of the storage; and
a display controller to cause a display to display motor operation information based on the motor operation data requested by the requestor.

15. The motor operation display system according to claim 14, further comprising:
a second detector to detect a communication error when receiving the motor operation data from the communicator and to re-request, upon detecting a communication error, the same motor operation data from the communicator.

16. A motor operation display device comprising:
the motor operation display system according to claim 14; and
a display to display motor operation information.
